(19) United States
(12) Patent Application Publication
(10) Pub. No.: US 2002/0138821 A1
(43) Pub. Date: Sep. 26, 2002

(54) Method and apparatus for seamless porting of object code between operating system environments

(76) Inventors: Vadim Furman, Cupertino, CA (US); Yacov Ben-Israel, Kfar-Gibton (IL); Guy Ray, Beit Nir (IL); Eyal Alaluf, Jerusalem (IL)

Correspondence Address: SHIBOLETH YISRAELI ROBERTS & ZISMAN, LLP, 350 FIFTH AVENUE, 60TH FLOOR, NEW YORK, NY, 10118

(21) Appl. No.: 09/767,133

(22) Filed: Jan. 23, 2001

(51) Int. Cl. G06F 9/45

(52) U.S. Cl. 717/128

(57) ABSTRACT

A method and apparatus, for providing seamless porting of source code originally written in Visual C++ for use under the Microsoft Windows operating system (WOS) environment, to computers operating under other Operating Systems such as the UNIX operating system (UOS), for the purpose of compilation and execution therein, comprising at least one computer using WOS and one computer using another OS, e.g. UOS, linked such that when a compilation of a C++ source code is initiated on the computer using the WOS, it is intercepted, and transferred to the computer using the UOS, for continuation of the compilation process. The source code is compiled for execution on the computer using the UOS, resulting in a UOS object code.

### FIELD OF THE INVENTION

The present invention is related to translation and compilation of source code. More particularly, the invention is related to the translation and compilation of source code, originally written to be executed under one operating system (OS) for operation under another OS.

### BACKGROUND OF THE INVENTION

Personal computers (PCs) operate under a designated OS. The most popular OS for PCs, today, is the Microsoft Windows OS (in its different versions) (WOS). In today's world a common practice for which PC's are used is programming source code. There are several programming languages in which source code can be written, some of which are defined according to ANSI standards. Usually writing such source code is accomplished by using one of the various development tools widely available on the market today.

A development tool allows the programmer to both develop the source code and create the build files necessary for the final compilation of the source code into its respective object code. Build files contain information about the files used in the compilation process and the interaction thereof. After the consummation of the development stage, once files are compiled, an object code is created which contains the specific instructions in machine language, to be used by the PC.

One popular development tool is Visual Studios (hereinafter “VS”)from Microsoft Corp., which provides a convenient environment for development of source code. The Visual Studio software package consists of several different applications, each of which deals with a different programming language. One of the programming languages provided by the environment is C++, which can be written using the Visual C++ application (VC++).

For the remainder of this application, specific OS's and source codes are mentioned. For the removal of doubt, it is noted that such specific language is not intended to diminish in any way from the general applicability of the invention to other OS's.

While the WOS is highly popular, there are still a significant number of computers running under other OSs, one of which is the Unix OS (UOS). UOS is significantly different from WOS, and has its own unique standards and specifications. Examples of the differences between WOS and UOS are files' names and extensions, and directory paths they utilize and create. Another difference relates to ANSI compliance and consequently the compilation of C++ source code created under the OSs. Whereas C++ source code written under WOS may not comply with all the standards of the ANSI, C++ source code written under UOS does comply with ANSI standards. Moreover, the build files required by a compilation process under each of the WOS or UOS, are also different. Therefore, a programmer writing a C++ source code under WOS may not be able to successfully compile the source code in a PC operating under a UOS.

Until the development of the present invention, whenever a programmer wanted to compile a C++ source code written under WOS, on a computer running under UOS, he had to manually convert the already written C++ source code so that it would compile under the UOS by editing the C++ source code to comply with the ANSI standards and with the specifications of the UOS. The process required the execution of the following steps: (1) Build, debug and validate the project under WOS; (2) Manually copy the project to a computer using UOS, (3) Preprocess all source files to be valid under UOS; (4) Create a UOS version of the build system (“make files”) for the project; (5) Build, debug and validate the project, this time under UOS; (6) Merge the changes made into the WOS original files in order to receive a source code which may be compiled on both OS's.

In order to be able to perform the above-mentioned steps, a programmer performing said steps has to be knowledgeable in UOS as well as the various flavors of C++ existing under UOS. Moreover, it is necessary to duplicate the project to the UOS based system, increasing the chance of eventual mismatch between the WOS source files and the resulting applications for the UOS, as the source codes are constantly debugged and upgraded. Differences in file names, file extensions, the build file, and other indications relating to the manner in which a compilation has to be performed further complicate the task. Obviously, enabling the programmer to perform these steps automatically would be advantageous since it decreases the chance of creating bugs during the translation process, and significantly reduces the time needed to complete the task.

### SUMMARY OF THE INVENTION

Thus, it is an object of the present invention to provide an apparatus and a method capable of creating an object code generated out of a WOS compilation of a C++ source code written under WOS, ready to be executed on a computer working under a UOS.

It is a further object of the present invention to provide an apparatus and a method for creating an ANSI-compliant object code generated from a WOS compilation of a source code written under WOS, ready to be executed on a computer working under another OS.

This object, and others not specified hereinabove, are achieved by the present invention, as exemplified in the embodiment disclosed herein, wherein the remote development architecture (RDA) is a system comprised of at least two computers, the first running under WOS and the second under another OS, for example UOS, which are communicatively linked. A C++ source code is developed on the first WOS computer, and once compilation of the C++ source code is initialized thereon, the process is intercepted, and the files are sent to the second computer, to be compiled thereon. The steps performed by the apparatus during the interception are: (1) transferring the relevant files to the second computer; (2) performing the relevant transformations, including the generation of an ANSI C++ standard compatible source code, required for a successful compilation on the second computer; (3) compilation on the second computer, to a UOS native object code, and the return of the UNIX object code to the first computer, so that the files may be easily located by both computers.

### BRIEF DESCRIPTION OF THE DRAWINGS

The present invention will be more fully understood from the following detailed description of an exemplary embodiment thereof, taken together with drawings in which:

FIG. 1 illustrates an exemplary embodiment of the system in which the invention should operate.

FIG. 2 is an illustration of an example of a packet header.

FIG. 3 is a diagram of the RDP format in accordance with an exemplary embodiment of the present invention.

### DETAILED DESCRIPTION OF THE PREFERRED EXEMPLARY EMBODIMENT

To aid one's understanding of the present invention, it helps to view the system by discussing its three major units which may be separated as follows and which will be more fully described: [a] Hardware comprising a Windows operating system (WOS) with an operating source code development environment, a non-Windows OS computer, and means for the two computers to exchange data and have equal access to certain common files; [b] software comprising conversion algorithms for converting Windows-generated source code into fully ANSI-compliant source code; and [c] the utilization of a remote development protocol format of the sort and in the manner taught by the present invention. These three major units will now be described in more particular detail in the order listed above, respectively.

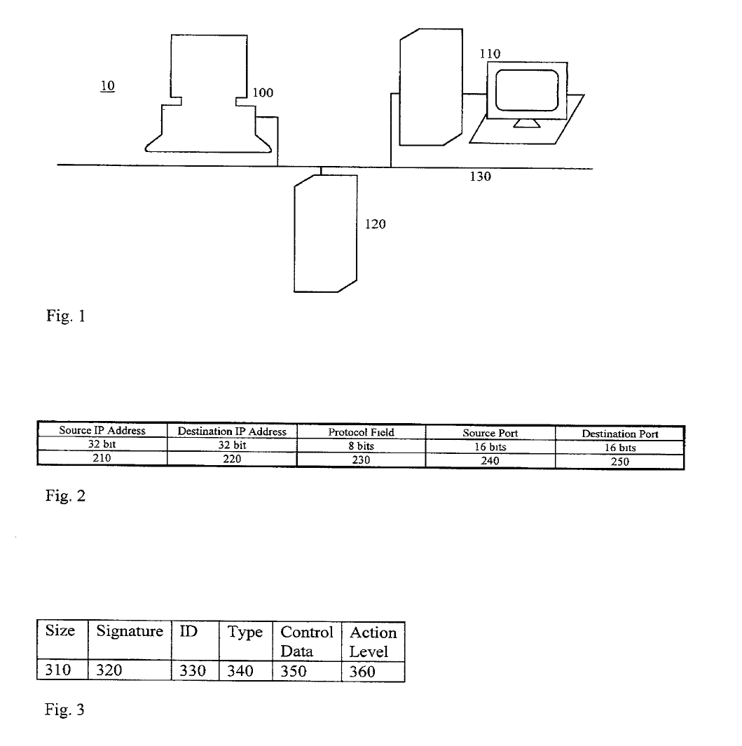

Reference is now made to FIG. 1, which illustrates an exemplary embodiment of the remote development architecture (RDA) of the present invention. The system described in FIG. 1, comprises a PC 100 that operates under WOS. More specifically, the Visual C++ source code is developed on Microsoft's C++ Visual Studio (VS), which is an environment used for the development of source code which is later compiled, again, using the VS, and executed on the PC's WOS environment. PC 100 has access to shared files saved on a server 120 capable of file sharing. PC 100 and server 120 are connected through a standard network, 130, capable of running standard Ethernet protocols, such as TCP/IP. A computer, 110, operating under the UOS is also connected to network 130 , with access to the file server 120 containing the shared files.

Initially, the user develops the source code under the WOS on PC 100, by using one of the standard development tools available for VC++, for example, the VS development system. VS has various hooks which permit monitoring of the steps the program is executing as it progresses in the compilation procedure. Once the development procedure is finished, the programmer compiles the source code. Before VS begins compilation, it informs of its intention of doing so.

In the next phase, the compilation procedure is halted by the invention described herein, using VS built-in functions, and the described apparatus takes control for the rest of the compilation procedure. From the user's perspective the things that need to be taken care of include the following: First of all the project, which is the collection of files required for a successful compilation of a VC++ project, must be placed in a shared storage location such as server 120, (or in another storage location accessible to both the WOS based system and UOS based system); then the user must use the apparatus-supplied configuration for UOS, which is added to VS during the initial installation of the apparatus described herein. This installation is done by taking advantage of VS ability to be augmented by the addition of various utilities, which extend the capabilities of the original VS application. The added configuration menus allow for various configuration settings.

In an alternative embodiment of the system, the shared files reside on PC 100 and in yet another embodiment the shared files reside on computer 110, using the UOS. Non-limiting examples of shared-file systems with which the present invention may be used include, networked file system TFS), common Internet file system (CIFS) and VSYNC which is used for web spread file systems.

Certain configuration data is required by computer 100 for successfully completing the desired compilation. These include such data as file locations in both the WOS and UOS environments, project names, compilation modes, log-on information, the type of UOS used, build instructions and the likes. The gathering of configuration data is implemented through standard WOS dialog boxes, using radio buttons, which permit selection from a plurality of options, check boxes, which allow the activation or deactivation of certain options, and text fields, which allow the user to enter certain configuration data.

By using text fields in the dialog boxes, users may enter the project name for each of the WOS and UOS projects. This allows for a separation between the data that is unique to each of the projects. However, it is an object of this invention to maintain a situation in which there is only one Visual C++ source code. The advantage of this object is clear, as there is only one source code to maintain, upgrade and debug.

In some cases it is necessary, or desirable, to compile the code ready for a debug session. Therefore, a check box is provided for allowing the user to enable or disable the debug mode. When the debug mode is enabled, the code is compiled with all the debug hooks necessary to run a debug session. In one exemplary mebodiment, the debugging is performed only under the UOS and the debuggerworks in the native environment. In an alternative embodiment, the debug session sends the error messages to the WOS and the debugger works in the WOS environment to handle the errors.

Another check box is provided to specify whether the user wants the preprocessed files to be retained. Normally the apparatus does not save the temporary files containing the specific Visual C++ source code translated into UOS format. However, in some cases it may be desirable to save such files in the permanent storage memory, for debugging purposes.

As the compilation is to be performed on another system, in this exemplary embodiment, on computer 110, operating under the UOS, which may have log-on requirements, another dialog box is provided to allow the entry of such information. When a communication is established between two computers 100 and 110, the log-on procedure is performed, ensuring that only valid users are able to perform such compilations. The dialog box must therefore contain the host name, the user name and the user password. The host name is used to identify the specific UOS-based computer 110 on which the compilation has to take place, as in a general network a plurality of such computers may be connected to the network 130. As an alternative to a host name, an Internet Protocol (IP) address can be used. The user name is a valid user name that is predefined on UOS-based computer 110. The user password is the password that allows the completion of the log on procedure. For the user's confidentiality the password is not displayed, or otherwise is replaced by a series of asterisks, one asterisk for each character used in the password.

In addition to usemame and password information, it is important to provide the path to the directory where the UOS object code shall reside. For example, such a path could be “/usr/others/mainwin”. It should be noted that there are no disk drive names under UOS, at least not in the manner used under WOS. Instead, UOS uses paths, similar to the one defined above. Therefore, a path map must also be included. A path map allows mapping of shared files from their WOS notation to the UOS notation. For example, files may be placed in server 120 on a hard disk drive (HDD) known as “F:” in a directory named “Project 1” (in alternative embodiments these files may be stored in any long term storage facility, such as a hard disk in the PC or one in the Unix computer, as long as both computers have equal access to the files). This may be mapped to a UOS address such as “/shared/project1”. During the stages of development and compilation, the apparatus is capable of accessing the data, regardless of which specific machine 100 or 110 is attempting to access the information.

In alternative embodiments, the user is accessing the system 10 via a dumb terminal, also known as an X-terminal. In such an instance it is required to provide the RDA system with the address of the target display, i.e. the dumb terminal. Therefore a check box enabling or disabling this feature is provided. If the check box is set to enabled, then an address, such as “terminal:0” or “<ip-address>:0” must be input. The IP-address used is the address which conforms with the IP and uniquely identifies the target display.

As mentioned hereinabove, VS's VC++ does not fully comply with the ANSI C++ standard. Therefore, C++ source code written under VS is not fully compatible with the requirements of the ANSI C++ standard. For this reason, before compiling a C++ source code written under WOS (for example, by using VS) on a UOS based machine, certain conversions have to be made. For example, the following code is a legal C++ source code generated by VS:

//declaration
struct A {

struct {

int a;

};
struct {

int b;

};

} X;

Note that the external struct declaration has a name, “X”, while both internal struct declarations are nameless. This source code, potentially, allows the reference “X.a” and “X.b” for reading data contained in these variables, as well as setting such variable's value in the following way:

X.a=5;

However, this source code is illegal under strict ANSI C++ standards, because the internal struct is nameless. Trying to compile the code “As Is” on a computer operating under UOS will result in a compilation error. When such code is detected, the apparatus of the present invention generates the necessary additions to make this code a legal code under the strict ANSI C++ standard. For the above example the following code will be generated:

//declaration
struct A {

struct {

int a;

}_new-name-a;
struct {

int b;

}_new-name-b;

} X;

Now, when “a” is referenced, the following reference will be used:

X._new-name-a.a=5;

In this exemplary embodiment of the present invention, the system identifies the problem, generates a unique name for the nameless struct and corrects all the references thereto, enabling a successful UOS compilation of source code originally written using VS under WOS. The actual search and replacement are performed using standard parsing techniques.

It should be noted that a name is added to each nameless struct, regardless of whether it is used or not, since it is an illegal construct to have a nameless struct. According to an exemplary embodiment of the present invention, “_new-name-a” has two portions, a prefix, such as “_u” and a sequential number. Using a sequential number is preferable over generating a random number for both simplicity of implementation and for consistent debugging. Therefore, the code generated in accordance with this embodiment may be as follows:

//declaration
struct A {

struct {

int a;

}_u123;
struct {

int b;

}_u124;

} X;

Consequently, assigning a value to the variable ‘a’ has the following format:

X._u123.a=5;

In some cases, under VS, where a template is defined, a default data type may be set. This means that whenever the template is used, if no specific data type is set, the default data type is used. The following is an example of such an instance:

//declaration
template <class T=int>
class MyTemplate: public T
{
//template definition goes here
....
};
//Usage
MyTemplate t1;
MyTemplate<double> t2;

Here, a template “MyTemplate” is declared with “int” (or integer) as the default data type for the template. Then, there is a usage of “MyTemplate”. Note that there is no specific data type set for t1, whereas “double” is set for t2. Since there is no setting of data type to t1, the default data type (int) is used. However, setting default data types as described is not allowed under ANSI C++ standards, and a specific declaration is required in every case. The source code of the above example will not compile on a computer running under UOS Upon detection of such code, the invention will replace all assumed data types with a specific setting of data types, consistent with the ANSI C++ standards. Therefore, for this example, the source code generated by the present invention is:

template <class T>
class MyTemplate: public T
{
//template definition goes here
....
};
//Usage
MyTemplate<int> t1;
MyTemplate<double> t2;

The following changes have been made—the default data type is removed from the template declaration. In addition, where usage of the template for “t1” assumed the default data type, now “int” is specifically set. However, it is notable that the usage of the template for “t2” specifically defined the double precision number data type, in accordance with ANSI requirements for UOS, and therefore is not changed.

As explained earlier, reference to locations under one OS must be translated to their respective address under the other system. For example, the Visual C++ source code may contain the following line:

#include c:\MyFiles\name.app

The path format used above is not a format recognized by the UOS. In the configuration menu the WOS reference to a PC hard disk is replaced by a path format recognized by the UOS, for example:

“/usr/public”

Under the method of the present invention, the disk name (“c:”) is stripped off of the full WOS path, leaving the specified path as “\MyFiles\name.app”. The next step is the conversion of the back slashes “\” into slashes “/”, as they are the separators used under the UOS. The apparatus now checks whether the path “/MyFiles/name.app” exists; if not, then such a path is created. Because, unlike the WOS, UOS is a case sensitive OS, which means that “MyFiles” is different from “myfiles”, all possible combinations of upper and lower case options are checked prior to concluding that such a path does not exist. If the path is found under the UOS, it is used to map the WOS path, regardless of the specific manifestation in upper and lower cases characters. Finally the translated instruction results in the following format:

#include/usr/public/myfiles/name.app

The above are mere examples of instances where such conversion is necessary. Based on the principals contemplated above, one skilled in the art will be able to add such conversion algorithms as may be necessary to make successful visual C++ source code conversions to ANSI C++ source code, for the purposes described in this invention.

In order to enable both user-transparent access to the source code under Windows, and the compilation requirements under UNIX, a targeted protocol is defined over the TCP/IP protocol. The Transfer Control Protocol (TCP) and the Internet Protocol (IP) are the protocols used in the third (Network) and fourth (Transport) layers of the standard communication model. In higher layers, users are permitted to define specific communication protocols in order to address the specific needs of their application. With reference to FIG. 2, it is seen that by providing a header 10 to the sequence of packets of a protocol, the source computer and destination computer are notified of the protocol used by the packet stream and can act accordingly in the interpretation of the packet payload which, by designating a targeted protocol, constitutes the content of the specific communication protocol.

The standard packet header 10 is illustrated in FIG. 2. The source address 210 contains the network address of the device that is sending the payload packet, while destination IP address 220 contains the network address of the destination device. This ensures that the payload data will be delivered to the right machine. In addition the header 10 also describes into which port, destination port 250 and from which port, source port 240, the data is transferred. However, for purposes of the present invention, this packet header information is not sufficient. It is also essential to know what is the specific protocol used so that both source and destination view the packet payload in the same way. By using the protocol field, 230, the source defines what is the protocol used for the transmission of the specific payload.

With reference to FIG. 3, the remote development protocol (RDP) is a non-symmetric point-to-point protocol, utilized by the apparatus of the present invention, that allows the sending of control messages from one terminal to another terminal but not vice versa. In the case of the system illustrated in FIG. 1, the control function is performed by PC 100, which is where the compilation process begins. The controlled unit is UOS computer 110. At the TCP/IP level each computer may be a source or destination for packets moving between the computers, however, at the RDP level the first computer retains control over the data transfer at all times. The RDP protocol format is defined in FIG. 3, and is the payload of information carried by the packet immediately following the first packet having the first header sent to the destination, providing UOS computer 110 with indications about the activities which are about to be required for the datastream.

How the information carried in the payload of the RDP protocol packet is treated depends on the content of the various fields shown in FIG. 3. Size field 310 contains information on the total size of the information to be provided in the specific communication. This number is usually provided by indicating the number of bytes. Signature field 320 is a field used to contain a signature to distinguish the RDP protocol data from other types of data that may be transferred to destination computer 110. This code is unique to the RDP and hence the destination can identify the data exchange as belonging to the specific type of protocol. ID field 330 contains a message identification number. This is usually a sequential number, which increases each time a new message is sent. This allows the destination to ensure that all the information it was supposed to receive was actually accepted and if an out of sequence message arrives, an error signal may be sent to the source to indicate of such a problem.

Type field 340 informs the destination computer 110 of the type of message being carried in the payload. Each type may have several possible actions which are described in action level field 360. An example of a type is a Request, the specific action of which will be defined in action level field 360. Possible actions include requests to change a directory, set environment variables and others. Another example of a type is an Interrupt, which indicates to the destination that the operation should be halted. In this case no specific action description is required as the action is self-evident. The remote development protocol format may contain a standard separator between the fields, such as the “@” character, which is otherwise not used, that makes it easier to identify each field when the system attempts to act upon the data received. Using the simplified RDP described above ensures a simple implementation of the connection between the source and destination participating in the code translation described above, conserves on system resources, and reduces the probability of erroneous access to compilations.

What is claimed is:

1. A source code development system for automatically developing standard-compliant source code from a first non-standard compliant source code, comprising a first computer with a first operating system having said non-standard compliant source code, a second computer with a second operating system, means of communication between said first computer and said second computer, means for intercepting a compilation being performed on the first computer, and means for converting said first source code into standard-compliant source code, wherein said standard-compliant source code is compilable on said second computer.

2. A source code development system in accordance with claim 1, wherein said first computer operates under a Windows operating system.

3. A source code development system in accordance with claim 2, wherein said compilation is initiated by using Microsoft's Visual Studio.

4. A source code development system in accordance with claim 1, wherein said second computer operates under a UNIX operating system.

5. A source code development system in accordance with claim 1, wherein said means of communication is a LAN.

6. A source code development system in accordance with claim 1, wherein said means of communication is a WAN.

7. A source code development system in accordance with claim 1, wherein said means of communication is the World Wide Web network.

8. A source code development system in accordance with claim 1, wherein code from said intercepted compilation is transferred to the second computer.

9. A source code development system in accordance with claim 8, wherein said code is a non-standard compliant code.

10. A source code development system in accordance with claim 8, wherein said second computer compiles said transferred code into source code native to said second computer.

11. A source code development system in accordance with claim 10, wherein said native source code is standard-compliant.

12. A source code development system in accordance with claim 11, wherein the execution of said native source code results in the generation of a native object code compatible for operation on said second computer.

13. A source code development system in accordance with claim 12, wherein said native object code is transferred back to the first computer.

14. A source code development system in accordance with claim 11, wherein said native source code is deleted from said second computer after the generation of said native object code.

15. A source code development system in accordance with claim 14, wherein said deletion of said native object code is optionally user-activatable.

16. A source code development system in accordance with claim 1, wherein said first computer and said second computer have access to at least one shared file.

17. A source code development system in accordance with claim 1, wherein said standard-compliant source code is compilable by either of first and second computers.

18. A source code development system in accordance with claim 16, wherein said shared files reside on said first computer.

19. The system of claim 16 where the shared file resides on said second computer.

20. A source code development system in accordance with claim 16, wherein said shared files reside on a file server.

21. A source code development system in accordance with claim 20, wherein said file server is connected to said system through LAN.

22. A source code development system in accordance with claim 20, wherein said file server is connected to said system through a WAN.

23. A source code development system in accordance with claim 20, wherein said file server is connected to said system through the World Wide Web.

24. A source code development system in accordance with claim 10, wherein said first computer includes means for controlling the compilation performed on the second computer.

25. A source code development system in accordance with claim 24, wherein said means for controlling comprises setting process configuration via a standard WOS dialog box.

26. A source code development system in accordance with claim 25, wherein said WOS dialog box permits naming of said project on said first computer.

27. A source code development system in accordance with claim 26, wherein said dialog box permits naming said fist computer with an IP address.

28. A source code development system in accordance with claim 25, wherein said dialog box permits naming of said project on said second computer.

29. A source code development system in accordance with claim 28, wherein said dialog box permits naming said second computer with an IP address.

30. The system of claim 25 where the user can enter the user name on the second computer.

31. The system of claim 30 where the user can enter the user password for the access into the second computer.

32. The system of claim 31 where the characters of the user password are replaced by a non-specific character.

33. The system of claim 32 where the non-specific character is an asterisk.

34. The system of claim 25 where the user can enter a path to a location in the format acceptable to the first computer.

35. The system of claim 34 where the path is mapped to a location path in the format acceptable to the second computer.

36. The system of claim 35 allowing for the mapping of a PC disk to a UNIX path.

37. The system of claim 25 where the user can enable the reference to an X-terminal by checking a check box.

38. The system of claim 37 where the user can provide the name of the X-terminal to be used.

39. The system of claim 38 where the name can be an IP address.

40. The system of claim 10 where the compiler is capable of parsing the source code and identifying a nameless struct.

41. The system of claim 40 further capable of generating a unique struct name to a nameless struct.

42. The system of claim 41 further capable of replacing old reference through a nameless struct by an ANSI C++ compliant reference using the unique struct name given to the nameless struct.

43. The system of claim 41 where the generated struct name is a combination of a prefix followed by a unique number.

44. The system of claim 43 where the prefix is combined from an underscore “_” followed by a character.

45. The system of claim 44 where the character is “u”.

46. The system of claim 43 where the number is 0 if the struct is the first nameless struct in the declaration, or the immediately following sequential number after the one last used for the nameless struct.

47. The system of claim 10 where the compiler is capable of parsing the source code and identifying a default parameter.

48. The system of claim 47 further capable of omitting the declaration of a default parameter.

49. The system of claim 48 further capable of replacing all cases of usage of default parameters by a specific declaration of a parameter at usage.

50. The system of claim 49 further capable of ignoring the cases where there was no usage of the default parameter.

51. The system of claim 10 further capable of identifying a path provided in the standard of first computer.

52. The system of claim 51 where the path is provided in standard format of a PC operating under WOS.

53. The system of claim 52 further capable of separating the disk drive information from the rest of the path.

54. The system of claim 53 where the disk drive name is replaced by a path name compatible with the second computer.

55. The system of claim 54 where the path is provided in a UOS format.

56. The system of claim 54 further capable of concatenating the path name with the rest of the path.

57. The system of claim 56 further capable of replacing all backslashes with slashes creating a path compatible with the notations of the second computer.

58. The system of claim 57 further capable of matching the path with all paths available regardless of upper or lower case.

59. The system of claim 58 further capable of creating the new path if no match is found.

60. The system of claim 1 further capable of using a dedicated remote development protocol between said first computer and said second computer comprising: a field containing a figure representative of the amount of data contained in a message, a field containing the identification of the remote development protocol, a field containing the information of the type of transaction, a field containing the information of the action associated with the type of the transaction and a field containing the identification number of the message.

61. The system of claim 60 where the amount of data is provided in the number of bytes.

62. The system of claim 60 where the type is a request from the second computer.

63. The system of claim 62 where the action associated with the request is a command to change a directory in the second computer.

64. The system of claim 62 where the action associated with the request is a command to set an environment parameter in the second computer.

65. The system of claim 60 where the type is an interrupt.

66. The system of claim 65 where the interrupt results in halt of compilation on the second computer.

67. The system of claim 65 where the interrupt results in suspension of the compilation on the second computer.

68. The system of claim 60 where the fields are separated by a standard separator.

69. The system of claim 68 where the separator is the “@” character.

70. A system for converting source code developed in a WOS environment into fully standard-compliant source code, said system including [a] a PC having an operating source code development environment and a second computer operating under a non-Windows operating system, and means for said PC and said second computer to exchange data; [b] means for converting Windows-generated source code into standard-compliant source code; and [c] means for directing said conversion, said means for directing comprising a remote development protocol format.

71. A system for converting source code developed in a WOS environment into fully standard-compliant source code in accordance with claim 1, wherein said PC and said second computer have equal access to at least some specified common data.

72. A method for converting Windows-generated source code into standard compliant source-code, comprising the steps of beginning a compilation of said Windows-generated source code in a Windows operating system environment, intercepting said compilation process and transferring files created by said process to a file location accessible by a non-Windows-based source code development environment, and permitting said compilation process to be completed in said non-Windows-based source code development environment.

73. A method for converting Windows-generated source code into standard compliant source-code in accordance with claim 72, comprising the further step of selecting whether to activate a debug-mode compilation in said non-Windows-based source code development environment.
